(19) United States
(12) Patent Application Publication
(10) Pub. No.: US 2026/0333188 A1
(43) Pub. Date: Oct. 22, 2026

(54) CONFIGURING A WIRELESS BACKHAUL LINK FOR RELAYING WIRELESS COMMUNICATION SIGNALS BETWEEN NODES

(71) Applicant: Nokia Solutions and Networks Oy, Espoo (FI)

(72) Inventors: Ilkka Antero KESKITALO, Oulu (FI); Esa Mikael MALKAMÄKI, Espoo (FI); Matti Einari LAITILA, Oulu (FI); Henri Markus KOSKINEN, Espoo (FI)

(21) Appl. No.: 19/115,641

(22) PCT Filed: Sep. 6, 2023
(86) PCT No.: PCT/EP2023/074426

§ 371 Date: Mar. 26, 2025

(30) Foreign Application Priority Data
Sep. 27, 2022 (GB) 2214068.5

(51) Int. Cl. H04W 40/24; H04W 76/12; H04W 92/24

(52) U.S. Cl. CPC H04W 40/24; H04W 76/12; H04W 92/24

(57) ABSTRACT

In an integrated access and backhaul (IAB) network, an IAB node may provide a wireless access service and a wireless backhaul service for user equipment. In such a network one or more IAB nodes may act as relay nodes relaying data between the UE and the core network. Embodiments relate to configuring a wireless backhaul link for relaying wireless communication packets between an IAB relay node and a centralised network node. The centralised IAB node maps a user equipment UE bearer associated with a UE to at least one backhaul bearer, the UE bearer being between the UE and the network node, and the backhaul bearer is between a relay node and the network node. The centralised node then transmits the mapping to the relay node.

### TECHNOLOGICAL FIELD

Various example embodiments relate to configuring a wireless backhaul link for relaying packets between nodes in a wireless communication network and in particular in one supporting integrated access and backhaul IAB.

### BACKGROUND

In an integrated access and backhaul (IAB) network, an IAB node may provide a wireless access service and a wireless backhaul service for user equipment. In such a network one or more IAB nodes may act as relay nodes relaying data between the UE and the core network. Service data of the user equipment may be sent by the IAB node to a further node such as a base station through a wireless backhaul link. The further node may be connected to a 5G core network element and may be termed an IAB donor node.

Where the IAB node is a mobile node an IAB donor node connected to the further node changes frequently and this can have a high signalling overhead particularly where there are descendants to the IAB node and the topology changes.

Embodiments seek to address these issues.

### BRIEF SUMMARY

The scope of protection sought for various example embodiments is set out by the independent claims. The example embodiments and features, if any, described in this specification that do not fall under the scope of the independent claims are to be interpreted as examples useful for understanding various embodiments of the invention.

According to various, but not necessarily all, example embodiments there is provided according to one aspect an apparatus for supporting wireless communication at a network node, said apparatus comprising: at least one processor; and at least one memory storing instructions that when executed by said at least one processor cause said apparatus or said network node at least to perform: mapping at least one user equipment UE bearer associated with a UE to at least one backhaul bearer, wherein said at least one UE bearer is between said UE and said network node, and said at least one backhaul bearer is between a relay node and said network node; and transmitting to said relay node, a message indicative of the mapping of said at least one UE bearer to said at least one backhaul bearer.

Embodiments provide a mapping of a user plane bearer, to a backhaul bearer that is between a relay node and the network node. The backhaul bearer may be terminated at the network node. In this way the backhaul connection does not require an intermediate protocol layer, so where the relay node is mobile (such as on a vehicle) there is no requirement to change topology as the cell that the relay node connects to changes.

In some example embodiments, said relay node is controlled at least in part by said network node.

In some example embodiments, said part comprises a distributed unit part of said relay node but not the MT mobile termination part.

In some example embodiments, said mapping comprises an association between said at least one UE bearer and said at least one backhaul bearer, said message comprises a UE context modification request.

In some example embodiments, said at least one UE bearer is carried in an F1-U tunnel between said relay node and said network node.

In some example embodiments, said backhaul bearer is identified by an identifier and said F1-U tunnel is identified by an identifier and said mapping comprises information linking said identifiers.

In some example embodiments, said apparatus is caused to perform acting as a secondary node in response to a first request to act as said secondary network node.

In some example embodiments, said first request is generated in the apparatus itself in response to determining that said relay node comprises an IAB integrated access and backhaul node.

In some example embodiments, said apparatus is caused to perform terminating said at least one backhaul bearer in response to receiving a request to terminate said at least one backhaul bearer.

In some example embodiments, at least one of said first request and said request to terminate said at least one backhaul bearer are received from a further network node.

In some example embodiments, said request to terminate said backhaul bearing is received as part of said first request, in other embodiments it is received as a separate request, where it is received as a separate request it may be received before or after the “first” request In some example embodiments, said apparatus or network node are further caused to perform: generating a request requesting said further network node to establish or modify a configuration for a radio connection for said at least one backhaul bearer; and transmitting said request to said further network node.

In some example embodiments, said request requesting said further network node to establish or modify comprises a secondary node modification required message.

In some example embodiments, said relay node comprises a mobile IAB node.

In some example embodiments, said mapping of said at least one UE bearer to said at least one backhaul bearer comprises mapping a plurality of said UE bearers to one of said backhaul bearers.

In some example embodiments, said apparatus comprises a control plane entity and a user plane entity, said control plane entity being caused to perform providing to said user plane entity information associated with said mapping of said at least one UE bearer to said at least one backhaul bearer, said user plane entity being caused to perform said mapping based on said information.

In some example embodiments, said apparatus or network node are further caused to perform receiving from said relay node a response to said message indicative of said mapping, said response confirming reception of said message indicative of said mapping at said relay node and confirmation of execution of said mapping of said at least one UE bearer to said at least one backhaul bearer at said relay node.

According to various, but not necessarily all, example embodiments there is provided according to a further aspect an apparatus for supporting wireless communication at a relay network node, for relaying packets between a user equipment and a network node said apparatus comprising: at least one processor; and at least one memory storing instructions that when executed by the at least one processor cause the apparatus or relay network node at least to perform: receiving from a network node a message indicative of a mapping between at least one UE bearer and at least one backhaul bearer, wherein said at least one UE bearer is between a UE and said network node and said at least one backhaul bearer is between said relay node and said network node; and in response to receipt of said message, executing said mapping of said at least one UE bearer to said at least one backhaul bearer based on said mapping between said at least one UE bearer and said at least one backhaul bearer.

In some example embodiments, said mapping comprises an association between said at least one UE bearer and said at least one backhaul bearer, and said message comprises a UE context modification request.

In some example embodiments, said at least one UE bearer is carried in an F1-U tunnel between said relay node and said network node and said mapping at least one UE bearer to said at least one backhaul bearer comprises mapping said at least one F1-U tunnel to said at least one backhaul bearer.

In some example embodiments, said apparatus or relay network node is caused to perform transmitting a response to said message indicative of said mapping, said response confirming execution of said mapping of said at least one UE bearer to said at least one backhaul bearer at said relay node.

According to various, but not necessarily all, example embodiments there is provided a wireless communication system comprising a relay network node supported by an apparatus according to a further aspect configured to receive packets from user equipment and relay packets received from said user equipment to a network node supported by an apparatus according to one aspect.

According to various, but not necessarily all, example embodiments there is provided an apparatus for supporting wireless communication at a further network node, said apparatus comprising: at least one processor; and at least one memory storing instructions that when executed by the at least one processor cause the apparatus or further network node at least to perform: receiving packets from a relay network node; determining whether said relay network node comprises an integrated access and backhaul relay node; and where so: generating a request requesting a network node to act as a secondary network node; and transmitting said request towards said network node.

According to various, but not necessarily all, example embodiments there is provided a method for supporting wireless communication at a network node, said method comprising:

mapping at least one user equipment UE bearer associated with a UE to at least one backhaul bearer, wherein said at least one UE bearer is between said UE and said network node, and said at least one backhaul bearer is between a relay node and said network node; and transmitting to said relay node, a message indicative of the mapping of said at least one UE bearer to said at least one backhaul bearer.

In some example embodiments, said method further comprises acting as a secondary node in response to a first request to act as said secondary network node.

In some example embodiments, said method further comprises terminating said at least one backhaul bearer in response to receiving a request to terminate said at least one backhaul bearer.

In some example embodiments, said method further comprises receiving at least one of said first request and said request to terminate said at least one backhaul bearer from a further network node.

In some example embodiments, said method further comprises generating a request requesting said further network node to establish or modify a configuration for a radio connection for said at least one backhaul bearer; and transmitting said request to said further network node.

In some example embodiments, said step of mapping of said at least one UE bearer to said at least one backhaul bearer comprises mapping a plurality of said UE bearers to one of said backhaul bearers.

In some example embodiments, said method further comprises receiving from said relay node a response to said message indicative of said mapping, said response confirming reception of said message indicative of said mapping at said relay node and confirmation of execution of said mapping of said at least one UE bearer to said at least one backhaul bearer at said relay node.

According to various, but not necessarily all, example embodiments there is provided a method for supporting wireless communication at a relay network node, for relaying packets between a user equipment and a network node said method comprising:

receiving from a network node a message indicative of a mapping between at least one UE bearer and at least one backhaul bearer, wherein said at least one UE bearer is between a UE and said network node and said at least one backhaul bearer is between said relay node and said network node; and in response to receipt of said message, mapping said at least one UE bearer to said at least one backhaul bearer based on said mapping between said at least one UE bearer and said at least one backhaul bearer.

In some example embodiments, said at least one UE bearer is carried in an F1-U tunnel between said relay node and said network node and said step of mapping at least one UE bearer to said at least one backhaul bearer comprises mapping said at least one F1-U tunnel to said at least one backhaul bearer.

In some example embodiments, said method further comprises transmitting a response to said message indicative of said mapping, said response confirming execution of said mapping of said at least one UE bearer to said at least one backhaul bearer at said relay node.

According to various, but not necessarily all, example embodiments there is provided a method for supporting wireless communication at a further network node, said method comprising: receiving packets from a relay network node; determining whether said relay network node comprises an integrated access and backhaul relay node; and where so: generating a request requesting a network node to act as a secondary network node; and transmitting said request towards said network node.

According to various, but not necessarily all, example embodiments there is provided a computer program comprising computer instructions which when executed by at least one processor on an apparatus are configured to control said apparatus to perform a method according to one or more of the method steps described above.

According to various, but not necessarily all, example embodiments there is provided a non-transitory computer readable medium comprising program instructions stored thereon for performing at least the following at a network node: mapping at least one user equipment UE bearer associated with a UE to at least one backhaul bearer, wherein said at least one UE bearer is between said UE and said network node, and said at least one backhaul bearer is between a relay node and said network node, generating a message for transmission of said mapping to a relay node and controlling said network node to transmit said message to said relay node.

According to various, but not necessarily all, example embodiments there is provided a non-transitory computer readable medium comprising program instructions stored thereon for performing at least the following at a relay node: mapping at least one UE bearer to at least one backhaul bearer based on a message received from a network node indicating a mapping of said at least one UE bearer and said at least one backhaul bearer.

According to various, but not necessarily all, example embodiments there is provided an apparatus for supporting wireless communication at a network node, said apparatus comprising: means for mapping at least one user equipment UE bearer associated with a UE to at least one backhaul bearer, wherein said at least one UE bearer is between said UE and said network node, and said at least one backhaul bearer is between a relay node and said network node; and means for controlling transmission to said relay node, of a message indicative of the mapping of said at least one UE bearer to said at least one backhaul bearer.

In some example embodiments, said means for controlling is further configured to control said apparatus to act as a secondary node in response to a first request to act as said secondary network node.

In some example embodiments, said means for controlling is further configured to control said apparatus to terminate said at least one backhaul bearer in response to receiving a request to terminate said at least one backhaul bearer.

In some example embodiments, at least one of said first request and said request to terminate said at least one backhaul bearer are received from a further network node.

In some example embodiments, said apparatus further comprises means for generating a request requesting said further network node to establish or modify a configuration for a radio connection for said at least one backhaul bearer; and means for controlling transmission of said request to said further network node.

In some example embodiments, said apparatus comprising a control plane entity and a user plane entity, said control plane entity comprising means for providing to said user plane entity information associated with said mapping of said at least one UE bearer to said at least one backhaul bearer, said user plane entity comprising said means for mapping, said means for mapping performing said mapping based on said information.

In some example embodiments, said apparatus further comprises means for receiving from said relay node a response to said message indicative of said mapping, said response confirming reception of said message indicative of said mapping at said relay node and confirmation of execution of said mapping of said at least one UE bearer to said at least one backhaul bearer at said relay node.

According to various, but not necessarily all, example embodiments there is provided an apparatus for supporting wireless communication at a relay network node, for relaying packets between a user equipment and a network node said apparatus comprising: means for receiving from a network node a message indicative of a mapping between at least one UE bearer and at least one backhaul bearer, wherein said at least one UE bearer is between a UE and said network node and said at least one backhaul bearer is between said relay node and said network node; and means, in response to receipt of said message, for executing said mapping said at least one UE bearer to said at least one backhaul bearer based on said mapping between said at least one UE bearer and said at least one backhaul bearer.

In some example embodiments, said apparatus further comprises means for controlling transmission of a response to said message indicative of said mapping, said response confirming execution of said mapping of said at least one UE bearer to said at least one backhaul bearer at said relay node.

According to various, but not necessarily all, example embodiments there is provided an apparatus for supporting wireless communication at a further network node, said apparatus comprising: means for receiving packets from a relay network node; means for determining whether said relay network node comprises an integrated access and backhaul relay node; means for generating a request requesting a network node to act as a secondary network node; and means for controlling transmission of said request towards said network node.

According to various, but not necessarily all, example embodiments there is provided an apparatus for supporting wireless communication at a network node, said apparatus comprising: mapping circuitry configured to map at least one user equipment UE bearer associated with a UE to at least one backhaul bearer, wherein said at least one UE bearer is between said UE and said network node, and said at least one backhaul bearer is between a relay node and said network node; and control circuitry configured to control transmission to said relay node, of a message indicative of the mapping of said at least one UE bearer to said at least one backhaul bearer.

In some example embodiments, said control circuitry is further configured to control said apparatus to act as a secondary node in response to a first request to act as said secondary network node.

In some example embodiments, said control circuitry is further configured to control said apparatus to terminate said at least one backhaul bearer in response to receiving a request to terminate said at least one backhaul bearer.

In some example embodiments, at least one of said first request and said request to terminate said at least one backhaul bearer are received from a further network node.

In some example embodiments, said control circuitry is further configured to control said apparatus to generate a request requesting said further network node to establish or modify a configuration for a radio connection for the backhaul bearer; and transmit said request to said further network node.

In some example embodiments, said apparatus comprises a control plane entity and a user plane entity, said control plane entity comprising circuitry configured to provide to said user plane entity information associated with said mapping of said at least one UE bearer to said at least one backhaul bearer, said user plane entity comprising said mapping circuitry, said mapping circuitry being configured to perform said mapping based on said information.

In some example embodiments, said apparatus further comprises circuitry for receiving from said relay node a response to said message indicative of said mapping, said response confirming reception of said message indicative of said mapping at said relay node and confirmation of execution of said mapping of said at least one UE bearer to said at least one backhaul bearer at said relay node.

According to various, but not necessarily all, example embodiments there is provided an apparatus for supporting wireless communication at a relay network node, for relaying packets between a user equipment and a network node said apparatus comprising: circuitry configured to receive from a network node a message indicative of a mapping between at least one UE bearer and at least one backhaul bearer, wherein said at least one UE bearer is between a UE and said network node and said at least one backhaul bearer is between said relay node and said network node; and mapping circuitry configured, in response to receipt of said message, to map said at least one UE bearer to said at least one backhaul bearer based on said mapping between said at least one UE bearer and said at least one backhaul bearer.

In some example embodiments, said apparatus further comprises circuitry configured to control transmission of a response to said message indicative of said mapping, said response confirming execution of said mapping of said at least one UE bearer to said at least one backhaul bearer at said relay node.

According to various, but not necessarily all, example embodiments there is provided an apparatus for supporting wireless communication at a further network node, said apparatus comprising: circuitry configured to receive packets from a relay network node; circuitry configured to determine whether said relay network node comprises an integrated access and backhaul relay node; circuitry configured to generate a request requesting a network node to act as a secondary network node; and circuitry configured to control transmission of said request towards said network node.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

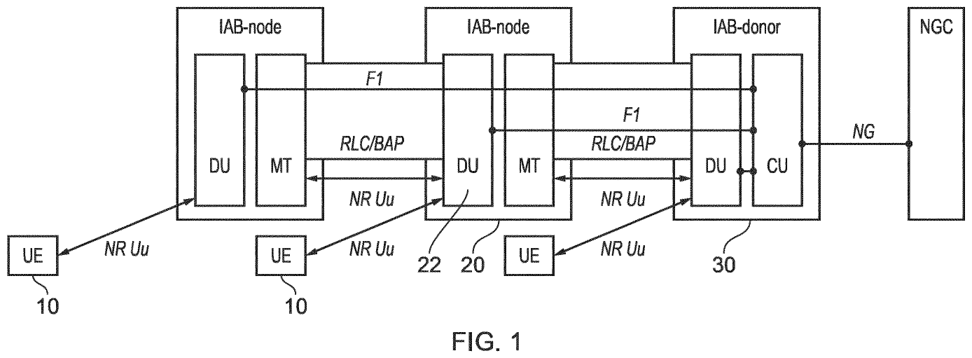

FIG. 1 illustrates a basic structure of an IAB network architecture;

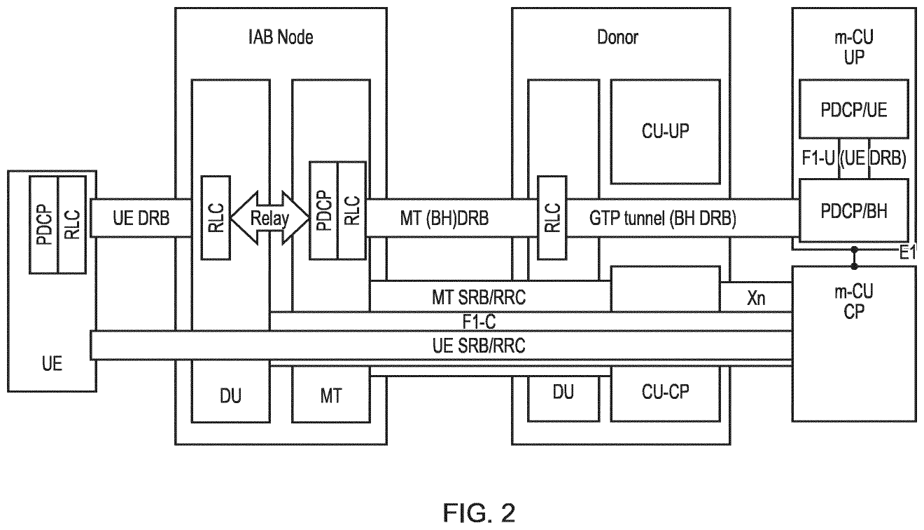

FIG. 2 illustrate a structure of the radio access network supporting single hop backhaul for a mobile IAB node according to an embodiment;

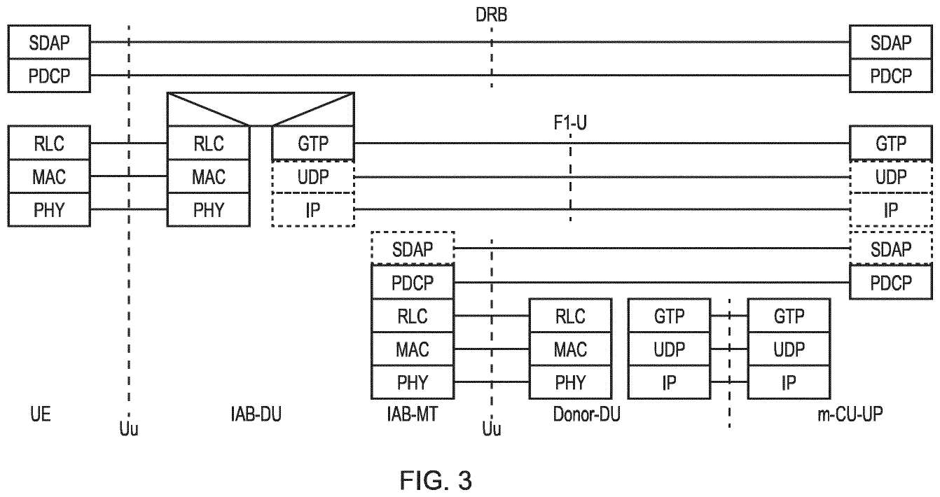

FIG. 3 illustrates a protocol stack and the split between the nodes according to an embodiment;

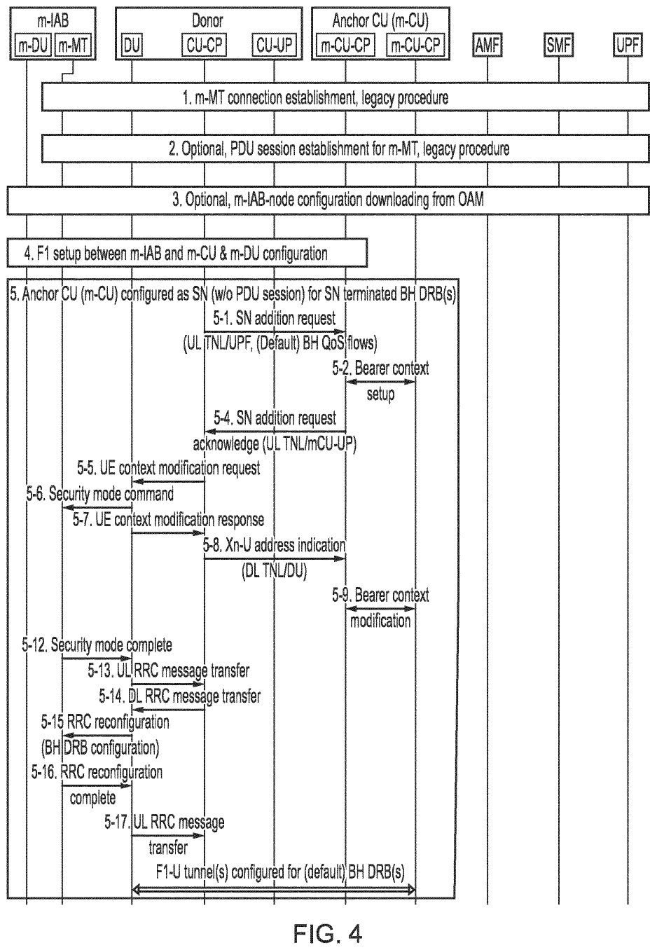

FIG. 4 schematically shows signalling between nodes in a mobile IAB-node integration procedure;

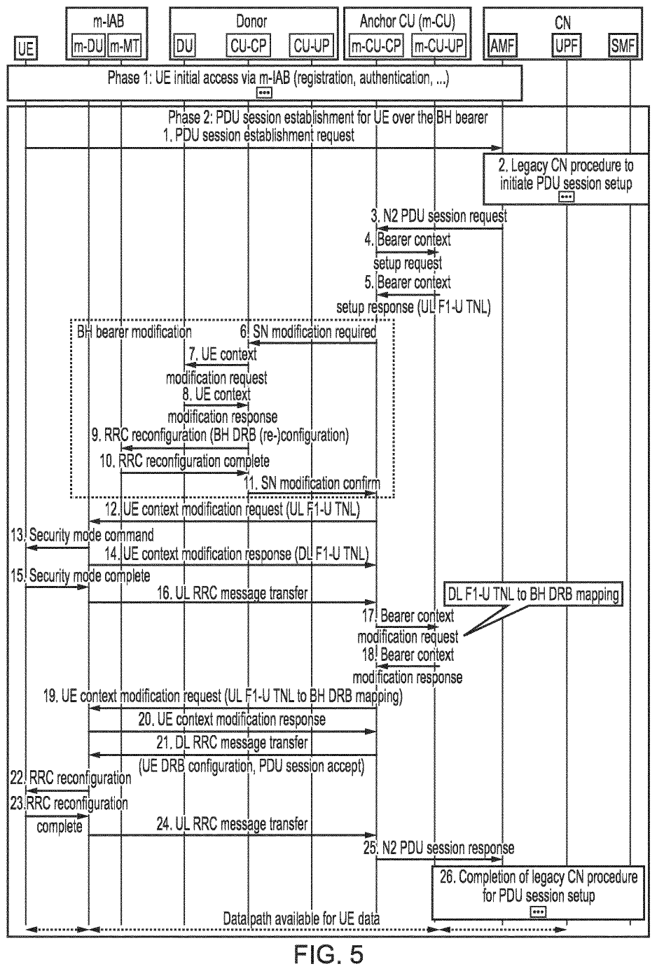

FIG. 5 shows signalling between nodes during the set up of the UE connection and how the data bearers are configured when accessing via the mobile IAB-node;

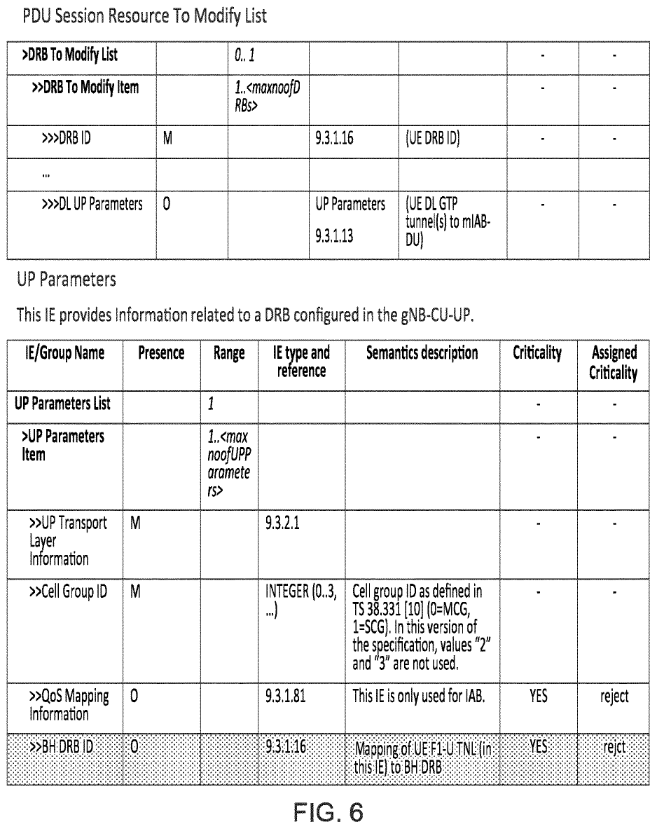

FIG. 6 schematically shows examples of modifications that might be made to the messages to support UE bearer configuration via the mobile IAB-node; and

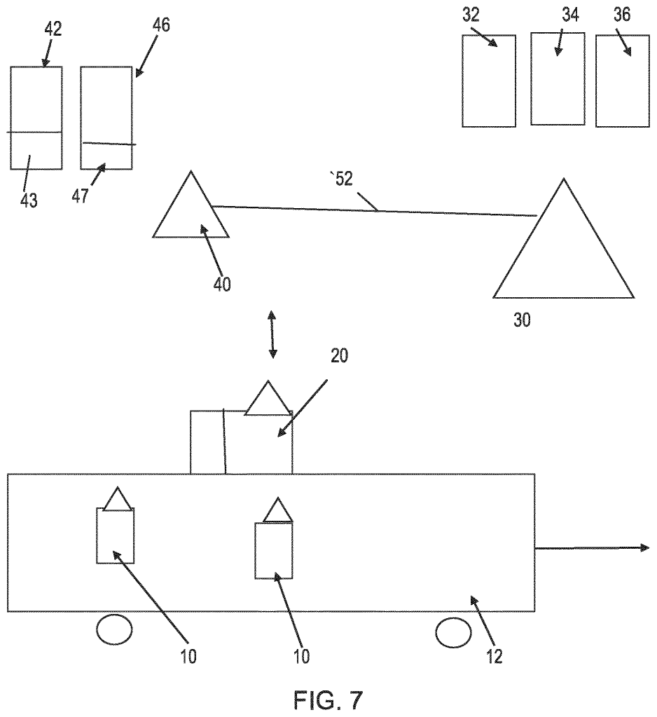

FIG. 7 schematically shows nodes in a network according to an embodiment.

### DETAILED DESCRIPTION

Before discussing the example embodiments in any more detail, first an overview will be provided.

In an integrated access and backhaul (IAB) network, an IAB node may provide a wireless access service and a wireless backhaul service for control and data transfer. One or more IAB nodes may act as relay nodes relaying data between the UE and the core network. An IAB network may have two types of IAB nodes, IAB-donor nodes which are base station that have wired backhaul to the 5G core network, while IAB-nodes or relay nodes use one or more wireless backhaul links to reach the IAB donor nodes. The IAB donor nodes therefore act as radio access gateways for the relay nodes.

Where the IAB node is a mobile node, an IAB donor node connected to the IAB node changes frequently and this can have a high signalling overhead particularly where there are descendants to an IAB node and the topology changes.

Embodiments seek to address these issues by using data bearers (DRBs) to carry backhaul data and mapping user equipment (UE) data bearers to backhaul data bearers used for the wireless backhaul link from the IAB-node to a node in the network. By doing this the IAB backhaul connection does not require an intermediate protocol layer, so where the IAB is mobile (such as on a vehicle) and changes frequently there is no requirement to change topology when the donor node that the IAB node connects to changes. Multiple UEs may use a single backhaul link using aggregation controlled in the SDAP (service data adaptation protocol), or corresponding, layer.

The relay IAB node looks to the donor node like a UE. In embodiments the donor node may determine that the IAB relay node is not a UE but is an IAB relay based on indication of device type during the IAB node access procedure, or receiving such information from the core network. With the knowledge of the connecting devise type (i.e. IAB node), the IAB donor may initiate a secondary node addition procedure and send a secondary node addition request message to another node. The another node may be pre-configured to select a particular node as the node to be later the terminating node for both backhaul and UE data bearers as well as controlling the distributed unit (DU) part of the IAB node. This another node is an anchor or centralised node and acts as a secondary node towards the donor network node for backhaul connection, but as a master node towards the core network for QoS flows to be mapped for UE bearers.

FIG. 1 shows an IAB network architecture, where UEs 10 connect with the distributed units 22 of IAB nodes 20. These IAB nodes acts as relay nodes for relaying packets between UEs and an IAB donor 30 which may be a base station and which provides wired access to the core network CN.

In this example layer 2 L2 relaying is used and a new protocol layer (BAP, Backhaul Adaptation Protocol) is introduced for routing and channel mapping. One of the main arguments for L2 relaying is that it can be hidden from the core network (CN) and no CN interfaces go over radio interfaces. This also implied that the centralized unit CU (donor) should be located in a fixed site with wired connection to the CN. This resulted in the IAB architecture with split gNB structure where the DU functions 22 are located in the IAB-node 20.

In this architecture, the CN interfaces are terminated at the IAB-donor and therefore the relaying is only a RAN functionality. The solution leverages split gNB architecture for Centralized Unit (CU) and Distributed Unit (DU) so that the CU functions are at the IAB-donor and the DU is at the IAB node. For the connection setup and communication with the parent node (which can be another IAB node or the IAB-donor), IAB-node hosts the MT (mobile termination) function corresponding to UE operation or a part of the UE operation.

For single hop mobile-IAB scenario, such IAB specifications result in excessive overhead over the BH backhaul link, unnecessary signalling and configurations of concerned nodes due to IAB-node mobility, and unnecessary HO:s (handovers) for access UEs connected to the mobile IAB-node. For example, routing is irrelevant for the single-hop backhaul link, thus making routing configurations and related routing functions obsolete for the Donor-DU and IAB-node. The term ‘single hop’ refers to single backhaul link between the mobile IAB-node and a fixed serving node which can be either a donor node or an intermediate IAB-node.

Embodiments seek to address such issues, and the following RAN structure is proposed for both the mobile-IAB and fixed-IAB scenario including a centralized CU function dedicated for the control of the mobile/fixed IAB-node as well as control (RRC) of the UEs connected to the cell(s) of the mobile/fixed IAB-node. Although the architecture proposed functions for both fixed and mobile IAB nodes, mobile IAB nodes will be considered below as it is particular advantageous in such scenarios. FIG. 2 illustrates the structure.

FIG. 2 shows the structure of the Radio Access Network supporting single-hop BH for mobile-IAB according to an embodiment.

The embodiment proposes the following specific features:
Centralized mobile-CU, m-CU which may be an anchor node controlling the mobile IAB-nodes (F1-C control plane) and access UEs (RRC radio resource control) connected to the mobile IAB-node
The Donor serves the cell for the IAB-node BH link carrying BH data radio bearers (DRBs)
Mobile IAB-MT is RRC connected to the serving (access network) node CU (Donor-CU)
m-CU-UP mobile central unit user plane terminates the DRBs for the BH and access links
UE DRBs can be aggregated (optional) for the BH link at the m-CU-UP
Donor CU and m-CU may communicate over Xn to configure the GTP tunnel to carry BH DRB between m-CU-UP and Donor-DU. Donor-CU configures Donor-DU for the BH connection
Mobile IAB-node connects to a fixed (stationary) node (Donor) that can be partly IAB capable
CP control plane signalling (F1-C UE RRC) can be carried over the Xn between Donor-CU and m-CU, and, over BH RRC between Donor and IAB-MT-as per Rer. 17 IAB specifications for CP/UP split of NR (new radio, a.k.a. 5G radio) dual connectivity (DC)
BAP backhaul adaptation protocol layer is not needed for the BH link; routing is unnecessary over a single link, UE bearer mapping (aggregation) to the BH bearer can done in the m-CU-UP
The logical structure of the mobile IAB is aligned with R16/17 IAB with CU in the fixed network and DU at the IAB-node, MT mobile termination establishing/maintaining the connection to the serving network for BH data.

The physical architecture for the network does not have to define the location of the m-CU and it can be a normal base station or a virtual node in the RAN cloud. Also the IAB Donor architecture can be cloud-based where the CU is in the cloud. The advantage of the cloud based architecture is the flexibility to serve large areas with the dedicated mobile functions serving the mobile IAB-nodes.

The UP protocol stack of the proposed solution is shown in FIG. 3:

At the top, there is the UE bearer (SDAP/PDCP) mapped to the F1-U user plane applying legacy principles. F1-U is conveyed in the DRB configured for the BH link. Multiple UE bearers (F1-U tunnels) can be aggregated to a single BH bearer in SDAP'. SDAP′ layer will differ from standard SDAP with the mapping (aggregation to BH bearers) as inputs are F1-Us carrying UE bearers instead of QoS flows from the core network.

Because the BH bearer is terminated at the m-CU-UP, Donor-CU and m-CU-CP have to negotiate QoS parameters and the transport layer (TNL) to be configured between the m-CU-UP and Donor-DU. This would correspond to the R17 partial migration where the F1 can be routed via the target donor's topology between the source CU and target donor-DU.

To further reduce the protocol overhead in the radio interface, header compression can be performed for the F1-U. Because the UE F1-U and SDAP′ are configured by the m-CU, there can be implementation dependent options to perform header compression. Furthermore, the protocol layers for F1-U can be non-standard where for example GTP layer is a modified protocol just that it unambiguously differentiates the UE bearers carried over the backhaul link.

Benefits of the proposed mobile IAB/VMR vehicle mobile relay structure may be at least the following:
Allows minimization/optimization or at least reduction/improvement of the access RAN (Donors) functions and the need for upgrades for IAB support; most of the enhancements to be implemented in the dedicated functions/entities i.e., m-CU and the mobile IAB-node
Topology adaptation (mobile IAB-node HOs, migration), i.e. BH link change, is limited to the single-hop and does not affect access UEs as long as the m-CU remains the same
If mobile IAB-node is served by a node of the IAB-network, routing re-configurations are not needed in the fixed part of the IAB network
Serving access nodes do not have to support all IAB functions; only minor upgrade to the legacy RAN (which may consist of a large number of nodes CUs/DUs) that normally do not need to support wireless backhauling
No routing over the mobile BH link; no BAP in the mobile IAB-node or serving node DU, nor routing (re-)configurations during mobility/migration
Flexibility to be applied for a variety of use cases and network deployment scenarios; this is partly thanks to (close to) transparency to the access RAN.

Referring to description of the embodiments shown in FIGS. 2 and 3, the following functions are explained:
Mapping of UE DRBs onto BH DRBs

The input to SDAP layer normally is QoS flows coming from UPF user plane function; here the input is F1-U carrying UE DRB. Hence, mapping of QoS flows to (BH) bearer cannot be done at SDAP based on the current standard
Aggregation of UE DRBs to BH DRBs. This is desirable as the number of LCIDs logical channel IDs may become limiting on the BH link.
Embodiments for mobile-IAB addressing the problems discussed above may have the following specific features:

### m-Cu

May act as a secondary Node (SN) of m-IAB node

May be added by Donor CU in standard SN addition procedure

Regarding UE DRBs. m-CU behaves as MN master node towards CN (UE bearer configurations, QoS flows, etc.) but as SN secondary node towards Donor (for BH connection).

Maps F1-U(s) (e.g. using GTP TEID tunnel endpoint identifiers) to BH DRB(s), m-CU-CP configures m-CU-UP for DL mapping.

Sends F1-U/BH DRB mapping to m-IAB

Initiates BH DRB setup (addition) or modification whenever needed to accommodate changing UE traffic (UE DRBs) using SN modification required-message.

### Donor-CU

During IAB-node integration procedure, becomes aware of “UE-type” (=mobile IAB-node, or IAB-node supporting BH over DRB) of the connecting device;
Determines the Donor-CU behaviour in the following phases (SN addition, F1-C forwarding)
Acting as MN for the m-IAB-node, adds m-CU as SN
Terminates IAB-MT RRC
Allows m-CU to initiate setup and modification of BH DRB in the form of SN terminated MCG bearer (where MCG is IAB-MT's radio link to Donor)
Standard operation when receiving SN modification required
Triggers Donor DU to (re-)configure RLC bearer of BH DRB between Donor DU and m-IAB-MT (standard operation)
Forwards CP (F1-C) traffic between m-IAB-DU and m-CU-CP, as per Rel. 17 IAB CP-UP separation.

### m-IAB-node

Receives F1-U/BH DRB mapping from m-CU
Reception (from m-CU) of F1-U configurations per UE DRB
UL: Maps F1-U(s) of UE DRB(s) to BH DRB(s) based on configured F1-U/BH DRB mapping.

It should be noted that although embodiments work particularly well for mobile m-IAB nodes which suffer from the problems outlined above, they would also apply to fixed IAB nodes.

The basis of embodiments is the DC dual connectivity operation where the Donor CU adds m-CU as the secondary node. This can be done in the mobile IAB-node integration procedure as shown in FIG. 4. Initially IAB-MT behaves like a normal UE establishing the connection to the network (Phase 1). If this is a power-up case, IAB-MT registers to the network and performs normal procedures like authentication, identification etc. with the core network (CN). The serving Donor becomes aware of the “UE type” which in this case is a mobile IAB-node. With that knowledge the Donor assumes the control plane (CP), i.e. the F1-C, of the mobile IAB-DU to be routed via the donor over the MT RRC signalling and over the XnAP signalling to the mCU. The Donor can be pre-configured with the information of the m-CU with which to communicate when a mobile IAB-node is connecting to the Donor.

This information may come also from OAM (Operations, Administration and Maintenance) as part of the node configuration data. Xn connection can be established in advance between the Donor and m-CU.

IAB-MT can establish a PDU session (Phase 2) to download configuration data from OAM (Phase 3). The data path in this phase may be routed via the Donor CU-UP.

In Phase 4, F1 between the mCU and IAB-DU is set up using standard F1 procedure. The messages are transferred in RRC messages between IAB-MT and the Donor, and in XnAP messages between the Donor and m-CU, as described above.

In Phase 5 of the integration procedure, the Donor adds m-CU as the secondary node (SN) for the anticipated SN terminated backhaul bearers. The SN addition request-message may optionally include a default set of backhaul (BH) data bearers (DRBs) in which UE traffic can be transferred over the BH link. The SN addition procedure is a standard procedure using existing messages. The procedure configures the transport for UL/DL UP tunnels between m-CU-UP and Donor-DU; messages 5-2 & 5-9 (for m-CU-UP) and 5-4 & 5-8 (for Donor-DU). At the end of the procedure IAB-MT has MCG master cell group configured with SN terminated bearers with transport configured for tunnels directly between Donor-DU and m-CU-UP. The IAB-node is now ready to activate IAB-DU cell(s) and accept UE access and traffic via the served cell(s).

FIG. 5 show how the UE connection is set up and how the data bearers are configured when accessing via the mobile IAB-node. In Phase 1 the UE accesses normally the cell and performs required routines with the CN, e.g. for authentication, security, etc. As m-CU controls the mobile IAB-DU, RRC signalling is with the m-CU-CP which also forwards the NAS messages to/from the CN.

For data connection, UE may initiate PDU session establishment (1). CN handles the request in a standard manner and send (by AMF) PDU session request to m-CU. The UP part of the m-CU (m-CU-UP) is configured with the new bearer(s) to be set up and the tunnelling information (to UPF/CN and UL TNL (Transport Network Layer) for m-CU-UP) is exchanged between m-CU-CP and m-CU-UP.

The m-CU being the SN, it can initiate modification of (SN terminated) BH DRBs (6). This is needed in case the UE requested traffic requires changes in the BH configuration. The procedure for SN modification uses standard signalling. The Donor sends SN modification confirm indicating accepted modification(s) (11).

IAB-DU is configured with the new bearer(s) (12). F1-U TNL information is provided to IAB-DU (12) for UL data and to m-CU-CP for DL data (14).

The mapping of UE F1-U tunnel(s) to BH DRB(s):
DL: m-CU-CP configures the mapping with BEARER CONTEXT MODIFICATION REQUEST (E1) message (17) where also the DL TNL information (for IAB-DU) is included.
UL: m-CU-CP configures the mapping to IAB-DU with UE CONTEXT MODIFICATION REQUEST (F1AP) message (19).

UE bearer on the access link is configured with legacy signalling (21-24). The procedure in RAN is completed with m-CU-CP sending PDU session response message to CN for completion the procedure also in the CN.

Examples of the modifications to the messages to support UE bearer configuration via the mobile IAB-node: UL TNL mapping for m-CU-UP and IAB-DU is shown in FIG. 6.

FIG. 7 shows a wireless communication network according to an embodiment. FIG. 7 schematically shows a vehicle 12 comprising a plurality of user equipment 10 and a relay node 20. The relay node 20 is an IAB mobile node and acts as a relay for packets between the user equipment 10 and the 5G core network. This has the advantage that when the vehicle 12 crosses between cells handover from the cells goes via the relay node 20 rather each of the individual user equipment 10 needing to perform handovers. Relay node 20 when within the cell of base station 30 connects to the base station 30. Base station 30 is a donor IAB node 30 and sees the relay node 20 like a user equipment with the same protocol stack. However, the donor becomes aware of the type of the accessing device during the integration procedure that identifies this node as a relay IAB node. In response to this knowledge the donor node 30 may initiate a secondary node addition procedure by transmitting a secondary node addition request message to centralised node 40 requesting that it becomes a secondary node.

Donor node 30 has apparatus associated with it, one of more of which may be within the node itself or may be remote from it within the cloud. The apparatus may be divided into different units, these may be physically distinct or simply logically distinct. They may comprise a control unit 32 configured to control the control plane and a control unit 34 configured to control the user plane and a distributed unit 36. The units may comprise a processor and a memory for storing instructions to control the processor to control the apparatus. The control units may be virtual functions in the cloud, or they may contain circuitry configured to perform these functions. Node 30 comprises transmitting and receiving circuitry for transmitting and receiving CP and UP data from other nodes and user equipment and is controlled by signals from the units 32, 34 and 36. It is the control unit 32 of the control plane that generates the secondary node addition request.

The centralised or anchor node 40 also has an apparatus associated with it that may be within the node 40 itself where the transmitting and receiving circuity is located or may be remote from it perhaps in the cloud. This apparatus comprises a control unit 42 for the control plane and a control unit 46 for the user plane. Again these may be physically distinct units, or they may simply be logically distinct each unit being configured to perform a particular function. The units may comprise a processor and a memory for storing instructions to control the processor to control the apparatus.

The donor IAB node 30 and the anchor node 40 may have a wired Xn backhaul link 52.

The user plane control unit 46 associated with the centralised node 40 comprises mapping circuitry 47 for mapping at least one user equipment bearer associated with a UE connected to the relay node to at least one backhaul bearer where the at least one UE bearer is between the UE and the relay node and the at least one backhaul bearer is between the relay node 20 and the centralised node 40. This mapping is performed in the user plane control unit 46, but is controlled by control circuitry 43 in the control plane unit 42 Once the mapping has been generated control circuitry 43 within the control plane entity 42 of the apparatus supporting the centralised node 40 controls the node 40 to transmit the mapping in the form of a UE context modification request which includes the uplink F1 tunnel mapping to the backhaul DRB to the relay node 20. The relay node 20 responds with the context modification response indicating that it has received the mapping and that when it receives data packets it will execute the mapping. In this way, a data path available for UE data is set up between the relay node 20 and the centralised node 40.

The relay node comprises mapping circuitry configured to map at least one UE bearer to at least one backhaul bearer based on a mapping received in a message from the anchor or centralised node 40. This provides a backhaul link in the form of an F1-U tunnel between the relay node and the anchor or centralised node 40. That is that the UE bearer is carried in an F1-U tunnel between the relay node 20 and the anchor network node 40 and this is configured as the backhaul link of the two nodes.

There can be a GTP tunnelling protocol tunnel between m-CU-UP 46 and Donor DU 36. The transport network layer (TNL) parameters (for GTP tunnel) are exchanged with SN addition request/response or SN modification required/confirm-messages. The GTP tunnel endpoints will then be known at the Donor-CU 32 (=tunnel endpoint at m-CU-UP 46 for UL data) and at the m-CU-UP 46 for DL data (tunnel endpoint at Donor-DU 36).

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The tern non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
   (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although embodiments have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the example embodiments believed to be of particular importance it should be understood that the Applicant claims protection in respect of any patentable feature or combination of features hereinbefore referred to and/or shown in the drawings whether or not particular emphasis has been placed thereon.

1.-25. (canceled)

26. An apparatus for supporting wireless communication at a network node, the apparatus comprising:
at least one processor; and
at least one memory storing instructions that when executed by the at least one processor cause the apparatus or the network node at least to perform:
mapping at least one user equipment (UE) bearer associated with a UE to at least one backhaul bearer, wherein the at least one UE bearer is between the UE and the network node, and the at least one backhaul bearer is between a relay node and the network node, the mapping comprises an association between the at least one UE bearer and the at least one backhaul bearer,, wherein the at least one UE bearer is carried in an F1-U tunnel between the relay node and the network node and the mapping at least one UE bearer to the at least one backhaul bearer comprises mapping the at least one F1-U tunnel to the at least one backhaul bearer; and
transmitting to the relay node, a message indicative of the mapping of the at least one UE bearer to the at least one backhaul bearer, wherein the message comprises a UE context modification request.

27. The apparatus according to claim 26, wherein the apparatus is caused to perform acting as a secondary node in response to a first request to act as the secondary network node.

28. The apparatus according to claim 27, wherein the apparatus is caused to perform terminating the at least one backhaul bearer in response to receiving a request to terminate the at least one backhaul bearer.

29. The apparatus according to claim 28, wherein the first request is received from a further network node.

30. The apparatus according to claim 29, wherein the apparatus is further caused to perform:
generating a request requesting the further network node to establish or modify a configuration for a radio connection for the at least one backhaul bearer; and
transmitting the request to the further network node.

31. The apparatus according to claim 30, wherein the request requesting the further network node to establish or modify comprises a secondary node modification required message.

32. The apparatus according to claim 31, wherein the relay node comprises a mobile IAB node.

33. The apparatus according to claim 32, wherein the mapping of the at least one UE bearer to the at least one backhaul bearer comprises mapping a plurality of the UE bearers to one of the backhaul bearers.

34. The apparatus according to claim 33, wherein the apparatus further comprises a control plane entity and a user plane entity, the control plane entity being caused to perform providing to the user plane entity information associated with the mapping of the at least one UE bearer to the at least one backhaul bearer, the user plane entity being caused to perform the mapping based on the information.

35. The apparatus according to claim 34, wherein the apparatus is further caused to perform receiving from the relay node a response to the message indicative of the mapping, the response confirming reception of the message indicative of the mapping at the relay node and confirmation of execution of the mapping of the at least one UE bearer to the at least one backhaul bearer at the relay node.

36. An apparatus for supporting wireless communication at a relay network node, for relaying packets between a user equipment and a network node the apparatus comprising:
at least one processor; and
at least one memory storing instructions that when executed by the at least one processor cause the apparatus or relay network node at least to perform:
receiving from a network node a message indicative of a mapping between at least one user equipment (UE) bearer and at least one backhaul bearer, wherein the at least one UE bearer is between a UE and the network node and the at least one backhaul bearer is between the relay node and the network node, the mapping comprises an association between the at least one UE bearer and the at least one backhaul bearer, and the message comprises a UE context modification request, wherein the at least one UE bearer is carried in an F1-U tunnel between the relay node and the network node and the mapping at least one UE bearer to the at least one backhaul bearer comprises mapping the at least one F1-U tunnel to the at least one backhaul bearer; and
in response to receipt of the message, executing the mapping of the at least one UE bearer to the at least one backhaul bearer based on the received message; and
perform transmitting a response to the message indicative of the mapping, the response confirming execution of the mapping of the at least one UE bearer to the at least one backhaul bearer at the relay node.

37. A system comprising:
an apparatus for supporting wireless communication at a network node;
at least one processor; and
at least one memory storing instructions that when executed by the at least one processor cause the apparatus or the network node at least to perform:
mapping at least one user equipment (UE) bearer associated with a UE to at least one backhaul bearer, wherein the at least one UE bearer is between the UE and the network node, and the at least one backhaul bearer is between a relay node and the network node, the mapping comprises an association between the at least one UE bearer and the at least one backhaul bearer, wherein the at least one UE bearer is carried in an F1-U tunnel between the relay node and the network node and the mapping at least one UE bearer to the at least one backhaul bearer comprises mapping the at least one F1-U tunnel to the at least one backhaul bearer; and
transmitting to the relay node, a message indicative of the mapping of the at least one UE bearer to the at least one backhaul bearer, wherein the message comprises a UE context modification request.

38. The system according to claim 37, wherein the apparatus is caused to perform acting as a secondary node in response to a first request to act as the secondary network node.

39. The system according to claim 38, wherein the apparatus is caused to perform terminating the at least one backhaul bearer in response to receiving a request to terminate the at least one backhaul bearer.

40. The system according to claim 39, wherein the first request is received from a further network node.

41. The system according to claim 40, wherein the apparatus is further caused to perform:
generating a request requesting the further network node to establish or modify a configuration for a radio connection for the at least one backhaul bearer; and
transmitting the request to the further network node.

42. The system according to claim 41, wherein the request requesting the further network node to establish or modify comprises a secondary node modification required message.

43. The system according to claim 42, wherein the relay node comprises a mobile IAB node.

44. The system according to claim 43, wherein the mapping of the at least one UE bearer to the at least one backhaul bearer comprises mapping a plurality of the UE bearers to one of the backhaul bearers.

45. The system according to claim 44, wherein the apparatus further comprises a control plane entity and a user plane entity, the control plane entity being caused to perform providing to the user plane entity information associated with the mapping of the at least one UE bearer to the at least one backhaul bearer, the user plane entity being caused to perform the mapping based on the information; and
wherein the apparatus is further caused to perform receiving from the relay node a response to the message indicative of the mapping, the response confirming reception of the message indicative of the mapping at the relay node and confirmation of execution of the mapping of the at least one UE bearer to the at least one backhaul bearer at the relay node.
